(19) United States
(12) Patent Application Publication
(10) Pub. No.: US 2015/0278879 A1
(43) Pub. Date: Oct. 1, 2015

(54) Interactive Kiosk for Displaying Different Types of Content Platforms and Related Technology

(71) Applicant: HORIZON MEDIA, INC., New York, NY (US)

(72) Inventor: Jill Nickerson, New York, NY (US)

(73) Assignee: HORIZON MEDIA, INC., New York, NY (US)

(21) Appl. No.: 14/224,361

(22) Filed: Mar. 25, 2014

(51) Int. Cl. G06Q 30/02; G06F 3/0482

(52) U.S. Cl. CPC G06Q 30/0276; G06F 3/0482

(57) ABSTRACT

Embodiments are directed to towards an interactive kiosk application for displaying demonstrations for different types of content platforms. A kiosk application may generate a plurality of selectors. The number or type of selector may depend on a demonstration context. The demonstration context may be a technology demonstration context or a consumer experience demonstration context. Selectors may correspond to a particular demonstration for a given content platform. Also, selectors may be associated with a technology feature or a consumer experience associated with the content platforms. Upon activation of a selector, the kiosk application may start the demonstration. The kiosk application may be arranged to generate and record interaction information corresponding to a user's interaction with the demonstration. The interaction information may be communicated to a kiosk management server computer for use in reporting.

### TECHNICAL FIELD

The present invention relates generally to content platforms, and more particularly, but not exclusively to displaying different types of content platforms.

### BACKGROUND

Advertising information may be presented to consumers using a wide variety of traditional and nontraditional content platforms. Some content platforms may include technology features that may enable the advertising information to be presented to consumers in many different ways and in many different places. Various content platforms may present advertising information using different display technologies, form factors, media, or the like. Further, modern content platforms may offer varying ways for consumers to interact with the content platform. And, in some cases, content platforms may enable dynamic content that may vary depending on interactions with the consumer. Moreover, new and varied content platforms are constantly being introduced, with some introducing new features and/or location access that may be new to most of the advertising industry. Accordingly, users that are tasked with selecting which content platforms to employ may not be familiar with features available on one or more content platforms or how those content platforms may relate to consumers. Thus, it is with respect to these considerations and others that the present invention has been made.

### BRIEF DESCRIPTION OF THE DRAWINGS

Nonlimiting and nonexhaustive embodiments of the present innovations are described with reference to the following drawings. In the drawings, like reference numerals refer to like parts throughout the various figures unless otherwise specified. For a better understanding of the described innovations, reference will be made to the following Description of Various Embodiments, which is to be read in association with the accompanying drawings, wherein:

FIG. 1 is a system diagram of an environment in which embodiments of the invention may be implemented;

FIG. 2 shows an embodiment of a client computer that may be included in a system such as that shown in FIG. 1;

FIG. 3 shows an embodiment of a network computer that may be included in a system such as that shown in FIG. 1;

FIG. 4 shows a logical diagram of a system for interactive kiosks for display different types of content platforms in accordance with at least one of the various embodiments;

FIG. 5 shows an overview flowchart for a process for an interactive kiosk for displaying different types of content platforms in accordance with at least one of the various embodiments;

FIG. 6 shows an overview flowchart for a process for interactively displaying content platform information in accordance with the various embodiments;

FIG. 7 shows an overview flowchart for a process for an interactive demonstration of a content platform in accordance with at least one of the various embodiments;

FIG. 8 shows a flowchart for a process for interactive demonstration of a content platform in accordance with at least one of the various embodiments;

FIG. 9 shows an interface for determining a context for an interactive demonstration of content platforms in accordance with at least one of the embodiments;

FIG. 10 shows an interface for displaying one or more selectors that enable a user to select a content platform to demonstrate in accordance with at least one of the various embodiments;

FIG. 11 shows an interface for displaying one or more selectors that enable a user to select a content platform to demonstrate in accordance with at least one of the various embodiments;

FIG. 12 shows an interface with a filter activated in accordance with at least one of the various embodiments;

FIG. 13 shows an interface with a selector that has been activated by a user in accordance with at least one of the various embodiments; and

FIG. 14 shows an interface for interacting with a content platform demonstration in accordance with at least one of the various embodiments.

### DETAILED DESCRIPTION OF VARIOUS EMBODIMENTS

The present innovations now will be described more fully hereinafter with reference to the accompanying drawings, which form a part hereof, and which show, by way of illustration, specific embodiments by which the invention may be practiced. These innovations may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present innovations may be embodied as methods, computers, or devices. Accordingly, the present innovations may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “In one of the embodiments” or “in at least one of the various embodiments” as used herein does not necessarily refer to the same embodiment, though it may. Furthermore, the phrase “in another embodiment” as used herein does not necessarily refer to a different embodiment, although it may. Thus, as described below, various embodiments of the innovations may be readily combined, without departing from the scope or spirit of the innovations.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein the term “content platform” refers to various devices and/or methods for providing commercial content, including advertising and/or marketing information to consumers. In some cases, content platforms may be arranged to be networked with one or more server computer, or other content platforms. Content including advertising and/or marketing content may be provided over the network to the content platform. Likewise, for some content platforms, information, such as, consumer interaction information, or the like, may be communicated from the content platform computer/device to a backend server computer.

Content platforms may be implemented using client computers with one or more features that may enable the content platform to perform in particular environments. For example, content platforms, may be equipped with one or more video screens of various sizes, touch screens, video camera, motion sensors, or the like. Also, content platforms may be deployed in particular places that enable their content to be accessible to consumers in various locations, such as, airplanes, airline lounges, restaurants, bars, taxi cabs, at point-of-sale stations, grocery stores, gas stations, indoors, outdoors, or the like.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed to towards an interactive kiosk application for displaying demonstrations for different types of content platforms. In at least one of the various embodiments, a kiosk application that may be operative on a client computer may be arranged to generate a plurality of selectors. In at least one of the various embodiments, the number and/or type of selector may be generated based on a demonstration context. In at least one of the various embodiments, the demonstration context may be a technology demonstration context, a consumer experience demonstration context, or the like.

Furthermore, in at least one of the various embodiments, each selector may correspond to a particular demonstration for a given content platform. Also, each of the selectors may be associated with a technology feature of content platforms or a consumer experience associated with the use of the content platforms. In at least one of the various embodiments, the selectors may be further determined based on a filter such that the filter corresponds to a technology feature of the content platform. The filter may be employed to determine which selectors may be enabled for activation. Further, in at least one of the various embodiments, the selectors may be generated based on the user that may be interacting with the kiosk application.

In at least one of the various embodiments, upon activation of one of the selectors, the kiosk application may start the demonstration and display the portion of the demonstration that may correspond to the current section of the demonstration. Accordingly, the kiosk application may generate and display section menu items that correspond to the current section of the demonstration. Also, action buttons may be generated for the current section as well.

In at least one of the various embodiments, the kiosk application may be arranged to generate and record interaction information that may correspond to a user's interaction with the demonstration. In at least one of the various embodiments, this interaction information may communicated to a kiosk management server computer for use in reporting.

In at least one of the various embodiments, the demonstration may be determined based on a automatic communication with a demonstration station. Also, in at least one of the various embodiments, the kiosk application may be arranged to communicate with a demonstration station enabling the user interaction to trigger actions that may be displayed on the demonstration station.

In at least one of the various embodiments, a kiosk application for installation on the client computer may be provided by a kiosk management server computer.

In at least one of the various embodiments, the kiosk application may be arranged to determine one or more demonstration stations based on the activated selector. The kiosk application may then guide the user to the determined demonstration station to experience the demonstration.

### Illustrative Operating Environment

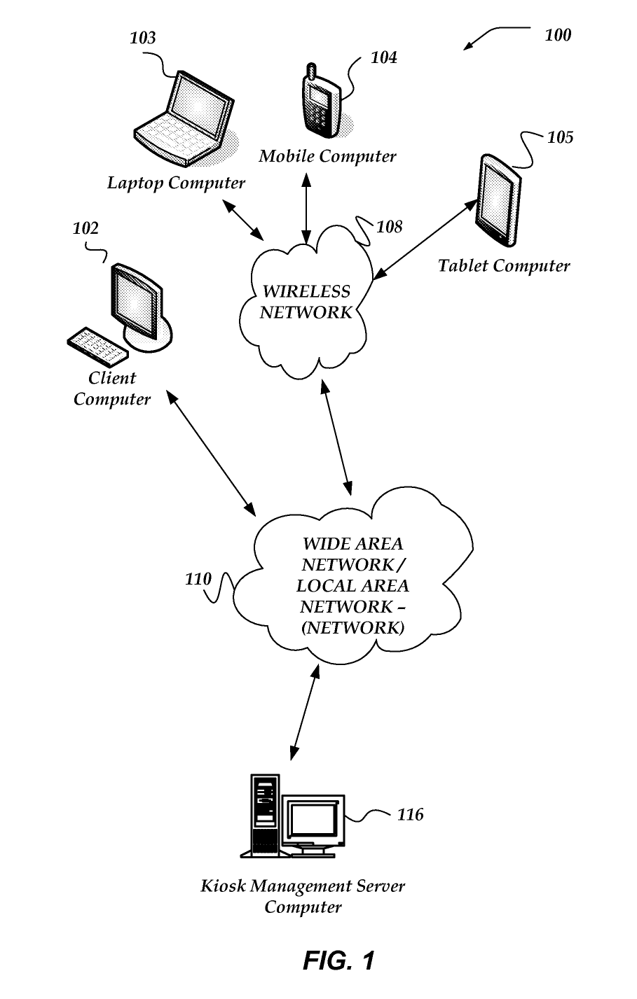

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs) (i.e., network) 110, wireless network 108, client computers 102-105, and Kiosk Management Server Computer 116.

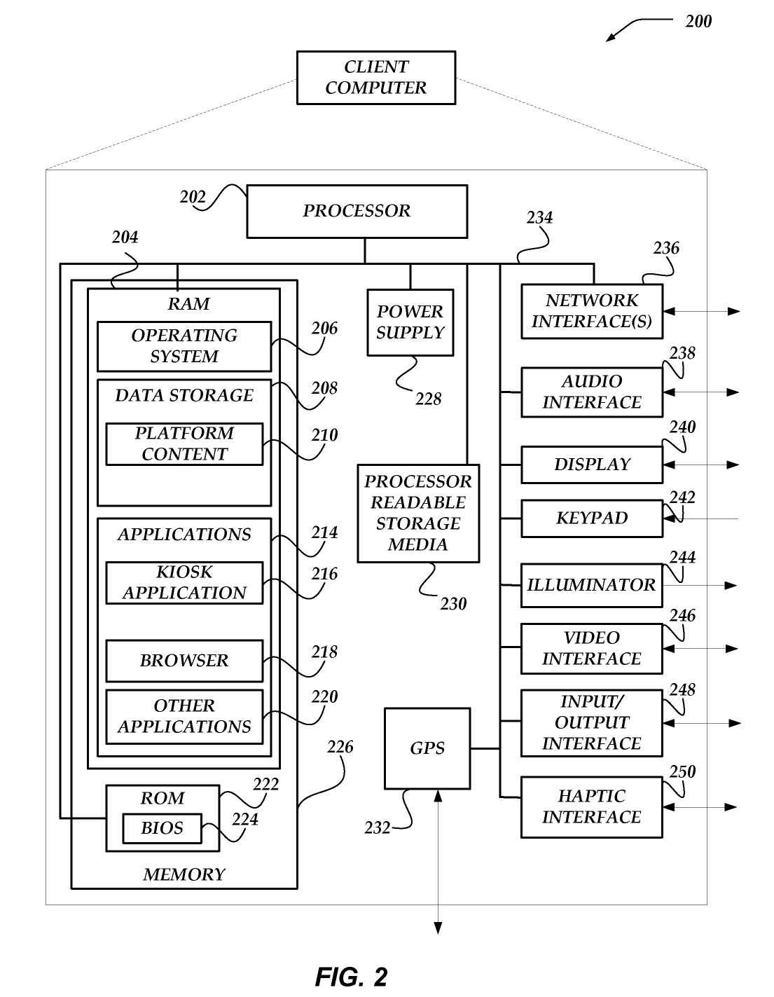

At least one embodiment of client computers 102-105 is described in more detail below in conjunction with FIG. 2. In one embodiment, at least some of client computers 102-105 may operate over one or more wired and/or wireless networks, such as network 108, and/or network 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, kiosk, point-of-sale, or the like. However, client computers 102-105 are not constrained to these services and may also be employed, for example, as for end-user computing in other embodiments. It should be recognized that more or fewer client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), JavaScript Object Notation (JSON), or the like, to display and send a message. In one embodiment, a user of the client computer may employ the browser application to perform various activities over a network (online). However, another application may also be used to perform various online activities.

Client computers 102-105 also may include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client computers, kiosk management server computer 116, or other computers.

Client computers 102-105 may further be configured to include a client application that enables an end user to log into an end-user account that may be managed by another computer, such as kiosk management server computer 116, or the like. Such an end-user account, in one nonlimiting example, may be configured to enable the end-user to manage one or more online activities, including in one nonlimiting example, search activities, social networking activities, browse various websites, communicate with other users, or the like. However, participation in such online activities may also be performed without logging into the end-user account.

Wireless network 108 is configured to couple client computers 103-105 and its components with network 110 and/or cloud network 112. Wireless network 108 may include any of a variety of wireless subnetworks that may further overlay stand-alone ad hoc networks, and the like, to provide an infrastructure-oriented connection for client computers 103-105. Such subnetworks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one nonlimiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, cloud network, cloud instance, or the like.

Network 110 is configured to couple network computers with other computers, including, kiosk management server computer 116, client computers 102-105, other networks, such as wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

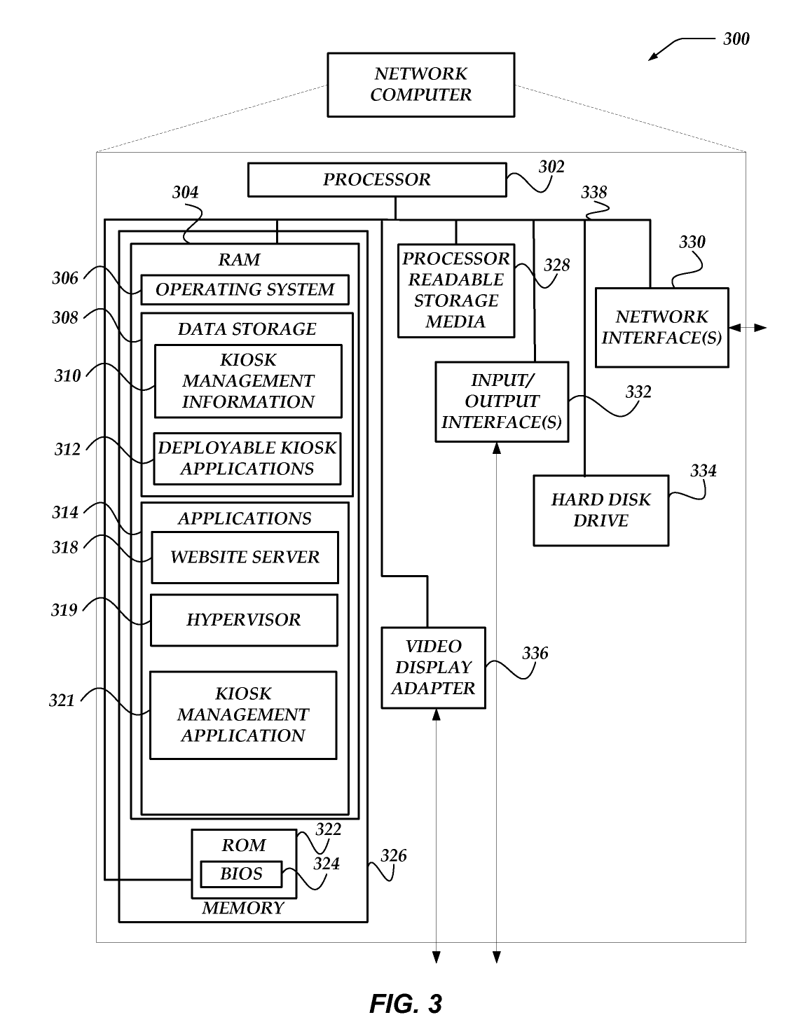

One embodiment of kiosk management server computer 116 is described in more detail below in conjunction with FIG. 3. Briefly, however, kiosk management server computer 116 includes virtually any network computer capable of providing kiosk applications to client computer, managing user access to kiosk applications, collecting and reporting one or more metrics for kiosk applications, or the like.

Although FIG. 1 illustrates kiosk management server computer 116 as a single computer, the innovations and/or embodiments are not so limited. For example, one or more functions of kiosk management server computer 116 may be distributed across one or more distinct network computers. Moreover, kiosk management server computer 116 is not limited to a particular configuration. Thus, in one embodiment, kiosk management server computer 116 may be implemented using a plurality of physical or virtualized network computers. In other embodiments, kiosk management server computer 116 may operate as a plurality of network computers within a cluster architecture, a peer-to-peer architecture, cloud-based environment, or the like. Accordingly, these innovations and embodiments are not to be construed as being limited to a single environment, and other configurations, and architectures are also envisaged.

In at least one of the various embodiments, cloud-based environments may comprise cloud networks that may include numerous physical computers and/or storage devices arranged such that the number and arrangement of the physical computers and devices is hidden from the users of the cloud network. In at least one of the various embodiments, cloud network infrastructure, the details and architecture of which may vary depending on the cloud network provider, may automatically provision and deploy applications and services onto the physical hardware underlying the cloud network with direct users intervention.

### Illustrative Client Computer

FIG. 2 shows one embodiment of client computer 200 that may be included in a system in accordance with at least one of the various embodiments. Client computer 200 may include many more or less components than those shown in FIG. 2. However, the components shown are sufficient to disclose an illustrative embodiment for practicing the present invention. Client computer 200 may represent, for example, one embodiment of at least one of client computers 102-105 of FIG. 1.

As shown in the figure, client computer 200 includes a processor 202 in communication with a mass memory 226 via a bus 234. In some embodiments, processor 202 may include one or more central processing units (CPU). Client computer 200 also includes a power supply 228, one or more network interfaces 236, an audio interface 238, a display 240, a keypad 242, an illuminator 244, a video interface 246, an input/output interface 248, a haptic interface 250, hardware security module 252, and a global positioning system (GPS) receiver 232.

Power supply 228 provides power to client computer 200. A rechargeable or nonrechargeable battery may be used to provide power. The power may also be provided by an external power source, such as an alternating current (AC) adapter or a powered docking cradle that supplements and/or recharges a battery.

Client computer 200 may optionally communicate with a base station (not shown), or directly with another computer. Network interface 236 includes circuitry for coupling client computer 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computer. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the client computer is powered. Also, illuminator 244 may backlight these buttons in various patterns when particular actions are performed, such as dialing another client computer. Illuminator 244 may also cause light sources positioned within a transparent or translucent case of the client computer to illuminate in response to actions.

Video interface 246 is arranged to capture video images, such as a still photo, a video segment, an infrared video, or the like. For example, video interface 246 may be coupled to a digital video camera, a web camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client computer 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client computer. For example, the haptic interface 250 may be employed to vibrate client computer 200 in a particular way when another user of a computer is calling. In some embodiments, haptic interface 250 may be optional.

Client computer 200 may also include GPS transceiver 232 to determine the physical coordinates of client computer 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 232 can determine a physical location within millimeters for client computer 200; and in other cases, the determined physical location may be less precise, such as within a meter or significantly greater distances. In one embodiment, however, client computer 200 may through other components, provide other information that may be employed to determine a physical location of the computer, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224, or the like, for controlling low-level operation of client computer 200. The mass memory also stores an operating system 206 for controlling the operation of client computer 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system, or the like. The operating system may include, or interface with a Java virtual machine module that enables control of hardware components and/or operating system operations via Java application programs.

Mass memory 226 further includes one or more data storage 208, which can be utilized by client computer 200 to store, among other things, applications 214 and/or other data. For example, data storage 208 may also be employed to store information that describes various capabilities of client computer 200. The information may then be provided to another computer based on any of a variety of events, including being sent as part of a header during a communication, sent upon request, or the like. Data storage 208 may also be employed to store social networking information including address books, buddy lists, aliases, user profile information, or the like. Further, data storage 208 may also store messages, web page content, or any of a variety of user generated content. Further, data storage 208 may be used for platform content 210 that may be employed by a kiosk application for displaying features and functionality for different types of content platforms.

At least a portion of the information stored in data storage 208 may also be stored on another component of client computer 200, including, but not limited to processor readable storage media 230, a disk drive or other computer readable storage devices (not shown) within client computer 200.

Processor readable storage media 230 may include volatile, nontransitive, nonvolatile, removable, and nonremovable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computer. Processor readable storage media 230 may also be referred to herein as computer readable storage media and/or computer readable storage device.

Applications 214 may include computer executable instructions which, when executed by client computer 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client computer. Applications 214 may include, for example, a browser 218, and other applications 220. Further, applications 214 may include kiosk application 216.

Browser 218 may include virtually any application configured to receive and display graphics, text, multimedia, messages, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client computer 200 to communicate with another network computer, such as floating network management server computer 116 shown in FIG. 1.

Other applications 220 may include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Also, in at least one of the various embodiments, a client computer, such as, client computer 200 may be arranged to be a content platform and/or provide services for one or more content platform. For example, a client computer, such as client computer 200, may be arranged to be a interactive platform for displaying content to a consumer at various locations.

### Illustrative Network Computer

FIG. 3 shows one embodiment of a network computer 300, according to one embodiment of the invention. Network computer 300 may include many more or less components than those shown. The components shown, however, are sufficient to disclose an illustrative embodiment for practicing the invention. Network computer 300 may be configured to operate as a server, client, peer, a host, cloud instance, or any other computer. Network computer 300 may represent, for example kiosk management server computer 116, and/or other network computers.

Network computer 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 3, network computer 300 also can communicate with the Internet, or other communication networks, via network interface unit 330, which is constructed for use with various communication protocols including the TCP/IP protocol. Network interface unit 330 is sometimes known as a transceiver, transceiving device, or network interface card (NIC).

Network computer 300 also comprises input/output interface 332 for communicating with external devices, such as a keyboard, or other input or output devices not shown in FIG. 3. Input/output interface 332 can utilize one or more communication technologies, such as USB, infrared, NFC, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network computer 300. Any general-purpose operating system may be employed. Basic input/output system (BIOS) 324 is also provided for controlling the low-level operation of network computer 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, nontransitory, nontransitive, removable, and nonremovable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computer.

Memory 326 further includes one or more data storage 308, which can be utilized by network computer 300 to store, among other things, applications 314 and/or other data. For example, data storage 308 may also be employed to store information that describes various capabilities of network computer 300. The information may then be provided to another computer based on any of a variety of events, including being sent as part of a header during a communication, sent upon request, or the like. Data storage 308 may also be employed to store messages, web page content, or the like. At least a portion of the information may also be stored on another component of network computer 300, including, but not limited to processor readable storage media 328, hard disk drive 334, or other computer readable storage medias (not shown) within network computer 300.

Data storage 308 may include a database, text, spreadsheet, folder, file, or the like, that may be configured to maintain and store user account identifiers, user profiles, email addresses, IM addresses, and/or other network addresses; or the like. Data storage 308 may further include program code, data, algorithms, and the like, for use by a processor, such as processor 302 to execute and perform actions. In one embodiment, at least some of data store 308 might also be stored on another component of network computer 300, including, but not limited to processor-readable storage media 328, hard disk drive 334, or the like.

Data storage 308 may include kiosk management information 310. In at least one of the various embodiments, kiosk management information 310 may include, information related to how users interact with kiosk, which users have installed kiosk applications on their computers, user profiles, application deployment policies, or the like. Furthermore, data storage 308 may be used for storing deployable kiosk applications 312 that may be made available for user to install on their computers.

Applications 314 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 314 may also include website server 318, hypervisor 319, and/or kiosk management application 321.

Website server 318 may represent any of a variety of information and services that are configured to provide content, including messages, over a network to another computer. Thus, website server 318 can include, for example, a web server, a File Transfer Protocol (FTP) server, a database server, a content server, email server, or the like. Website server 318 may provide the content including messages over the network using any of a variety of formats including, but not limited to WAP, HDML, WML, SGML, HTML, XML, Compact HTML (cHTML), Extensible HTML (xHTML), or the like.

### Illustrative Logical System

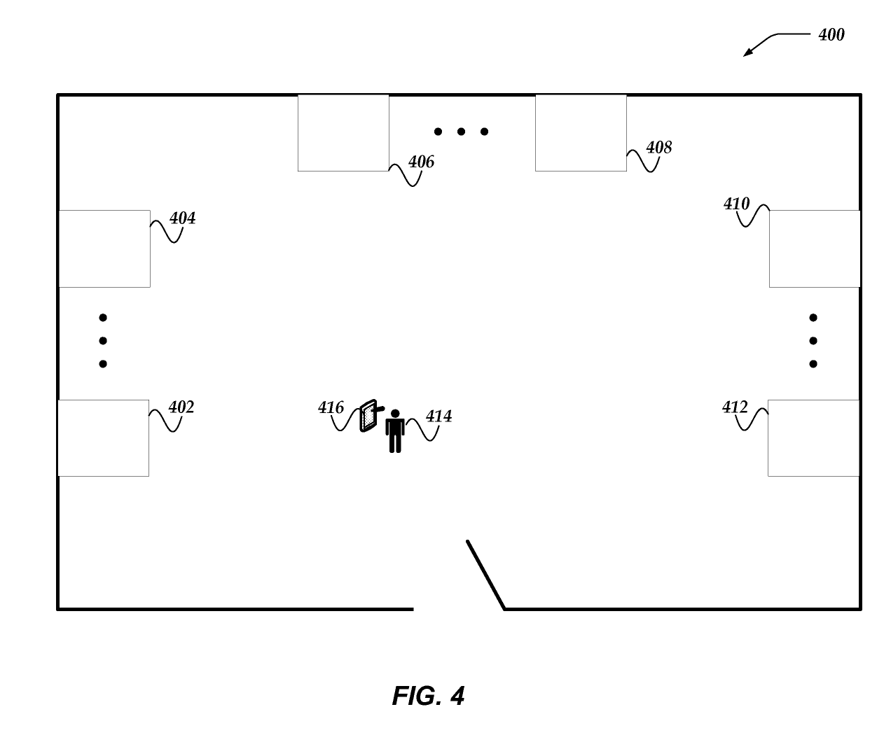

FIG. 4 shows a logical diagram of system 400 for interactive kiosks for display different types of content platforms in accordance with at least one of the various embodiments. In at least one of the various embodiments, multiple demonstration stations for demonstrating the features of one or more content platforms may be arrayed in an area and/or room. Accordingly, in at least one of the various embodiments, a user may walk through the room and observe authentic/real-world demonstrations for each of the content platforms.

In at least one of the various embodiments, actual physical examples of the content platforms may be presented to the users at each demonstration station. For example, demonstration stations may include equipment, such as, computers, televisions, touch screens, point-of-sale systems, sound systems, or the like, arranged to demonstrate the features of the content platform.

In at least one of the various embodiments, demonstration stations, such as, demonstration stations 402-412 may be arranged to include actual equipment that may be representative of how the content platforms may be employed in real world situations. Accordingly, in at least one of the various embodiments, a user, such as, user 214 may experience the different content platforms by observing and interactions with the demonstration stations.

Furthermore, in at least one of the various embodiments, a kiosk application may be operative on mobile computer 416. In at least one of the various embodiments, the kiosk application may be arranged to communicate information and interact to user 414 to guide him or her during their review of content platforms.

In at least one of the various embodiments, the kiosk application may be arranged to communicate information about the content platforms to users based on multiple contexts, such as, technology features of the content platform, consumer targeting, audience locations, or the like.

In at least one of the various embodiments, kiosk applications arranged to communicate information organized by technology features of the content platform may enable users to determine which content platforms may support one or more desired technology features. Likewise, in at least one of the various embodiments, content platforms that omit one or more selected or desired features may be filtered out and/or excluded. For example, in at least one of the various embodiments, a user, such as, user 414, may want to review/explore content platforms that include RSS feed support. In this example, the kiosk application may indicate on its display which content platforms include RSS feed support.

Also, in at least one of the various embodiments, kiosk applications arranged to communicate information organized by consumer/audience characteristics may enable users to determine which content platforms may effectively target one or more audience demographic groups. Likewise, in at least one of the various embodiments, content platforms that omit one or more selected or desired consumer groups or audience locations may be filtered out and/or excluded. For example, in at least one of the various embodiments, a user—such as user 414—may want to review/explore content platforms that may be operative onboard airlines flights. In this example, the kiosk application may indicate on its display which content platforms may be operative on onboard airline flights.

In at least one of the various embodiments, the kiosk application may be arranged to communicate over a network with one or more of the demonstration stations. In at least one of the various embodiments, this may enable the kiosk application to operate cooperatively with the demonstration room and/or the demonstration stations. For example, in at least one of the various embodiments, if user 414 is using the kiosk application to determine which content platforms support RSS feeds, the kiosk application may communicate information to one or more demonstration stations such that they activate an indicator (e.g., a signal light) to indicate that they support RSS feeds. Thus, in this example, the user may be enabled to determine from a distance which demonstration station support of desired feature.

Likewise, in at least one of the various embodiments, the kiosk application may be arranged to directly interact with a demonstration station such that the actions of the demonstration station may be coordinated and/or controlled by the kiosk application. For example, the kiosk application may communicate information to the demonstration station enabling it to display particular content that corresponds with the user's interaction with the kiosk application.

### Generalized Operation

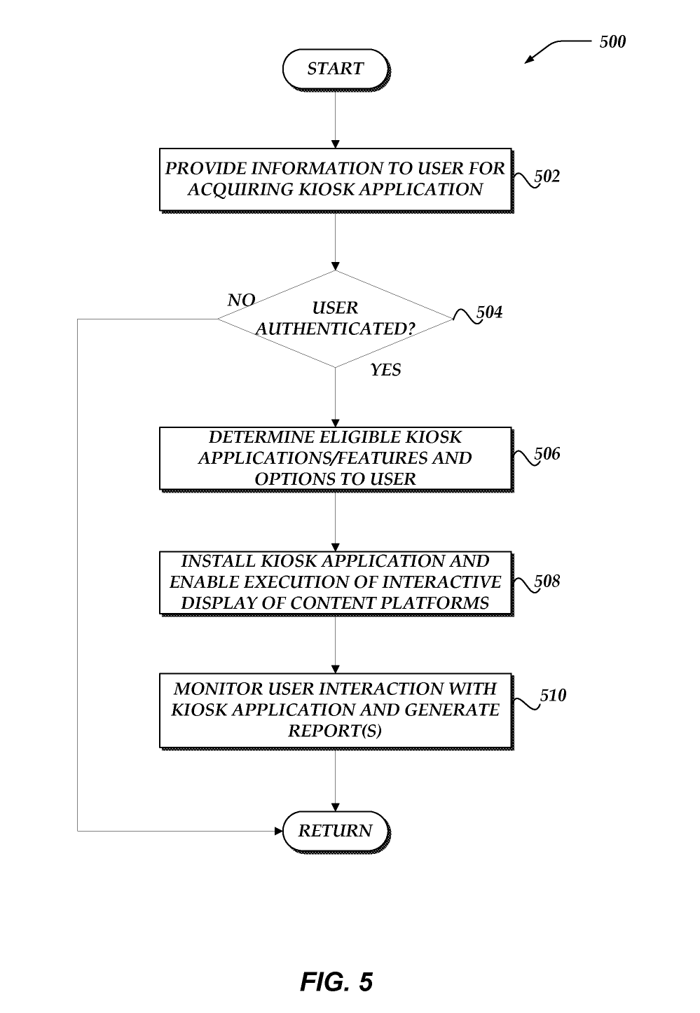

The operation of certain aspects of the invention will now be described with respect to FIGS. 5-8. In at least one of various embodiments, processes 500, 600, 700, and 800 described in conjunction with FIGS. 5-8, respectively, may be implemented by and/or executed on a network computer, such as network computer 300 of FIG. 3. In other embodiments, these processes or portions of these processes may be implemented by and/or executed on a plurality of network computers, such as network computer 300 of FIG. 3. Further, in other embodiments, these processes or portions of these processes may be implemented by and/or executed on one or more client computers, such as client computer 200 as shown in FIG. 2. However, embodiments are not so limited and various combinations of network computers, or the like, may be utilized.

FIG. 5 shows an overview flowchart for process 500 for a interactive kiosk for displaying different types of content platforms in accordance with at least one of the various embodiments. After a start block, at block 502, in at least one of the various embodiments, information for acquiring a kiosk application may be provided to a user. In at least one of the various embodiments, an email may be delivered to the user that enables the user to download the kiosk application onto a mobile computer. In other embodiments, the kiosk application may be provided as an attachment in an email or other message.

Further, in at least one of the various embodiments, the kiosk application may be previously installed on the mobile computer. In such cases, the user may be provided with credential information for activating the kiosk application. For example, a user may be provided a mobile computer, such as, a mobile tablet that already includes an installed kiosk application. In such circumstances, the user may be provided credential information (e.g., username and password, or the like) for logging into or otherwise registering with the kiosk application. At decision block 504, in at least one of the various embodiments, if the user is authenticated, control may flow to block 506; otherwise, control may be returned to calling process.

At block 506, in at least one of the various embodiments, one or more kiosk applications, features of a kiosk application, or other options may be determined for the user. In at least one of the various embodiments, the actions in block 502 may direct a user to a website, or other remote application that may include multiple kiosk applications. One or more of these kiosk applications may be available to the user depending on their role and/or their credentials. For example, a user with a guest level credentials may be enabled to access or download a “demo” kiosk application rather than a kiosk application designed for a particular type of user.

Likewise, in at least one of the various embodiments, one or more kiosk applications may include one or more selectively activated features and/or options. One or more sets or lists of such features or options may be determined for a user depending on their credentials and/or role.

Also, in at least one of the various embodiments, users maybe associated with one or more roles that may determine in part the set of features and/or options that may be available to them. In some embodiments, the kiosk application may be arranged to enable a user to select features and/or options from a list, or the like. In other embodiments, the kiosk application may be configured to automatically determine the features and/or options that may be made available to a user based on their credential information. In at least one of the various embodiments, in the absence of credential information for a user, the kiosk application may be arranged to determine a default set of features and/or options (e.g., guest access) for the current demonstration session.

In at least one of the various embodiments, the kiosk application may be arranged to determine one or more features and/or options based on the physical location of the client computer that may be hosting the kiosk application. For example, in at least one of the various embodiments, if the client computer determines it is near a particular demonstration station, one or more, features and/or options of the kiosk application may be enabled accordingly.

At block 508, in at least one of the various embodiments, the kiosk application may be installed and/or otherwise activated on a mobile computer for the user. In at least one of the various embodiments, the kiosk application may enable the user to interactively examine information related to one or more content platforms.

In at least one of the various embodiments, the kiosk application may be arranged to provide a guided demonstration one or more content platforms. Further, if the kiosk application is active in a showroom, such as, showroom 400, the kiosk application may be arranged to provide a guided tour that may be coordinated with one or more demonstration stations.

At block 510, in at least one of the various embodiments, user interaction with the kiosk application may be monitored and/or recorded. In at least one of the various embodiments, the information associated with user interaction may be stored and/or employed for generating one or more reports. In at least one of the various embodiments, information regarding how one or more users interact with the kiosk application may be provided to a kiosk management server computer, such as, kiosk management server computer 300.

In at least one of the various embodiments, the user interaction information may be provided to a kiosk management server computer using a wired or wireless network. In some cases, in at least one of the various embodiments, if the kiosk application is unable to access a network sufficient for communicating with the kiosk management server computer, the kiosk application may store the interaction information until such time as communication with the kiosk management server computer may be enabled. In such instances, the interaction information may be stored locally on the client computer using local data storage, such as, data storage 208.

In at least one of the various embodiments, the kiosk application may be arranged to automatically communicate the interaction information to a kiosk management server. However, in at least one of the various embodiments, the kiosk application may be arranged to request the consent of the user before communicating the interaction information to a kiosk management server. Also, in at least one of the various embodiments, the kiosk application may be arranged to request the consent of the user before capturing or otherwise recording the interaction information.

In at least one of the various embodiments, the kiosk application may be arranged to aggregate the interaction information for all users that may interact with the kiosk application. In some embodiments, aggregation of the interaction information may anonymize the interaction information such that the interaction information an individual user may be obscured.

In at least one of the various embodiments, interaction information may be stored using one or more well-known file formats and/or database formats, such as, XML, SQL, CSV, JSON, or the like. In at least one of the various embodiments, the interaction information may be encrypted using one or more well-known cryptographic techniques to protect against unauthorized use of the information. Next, in at least one of the various embodiments, control may be returned to a calling process.

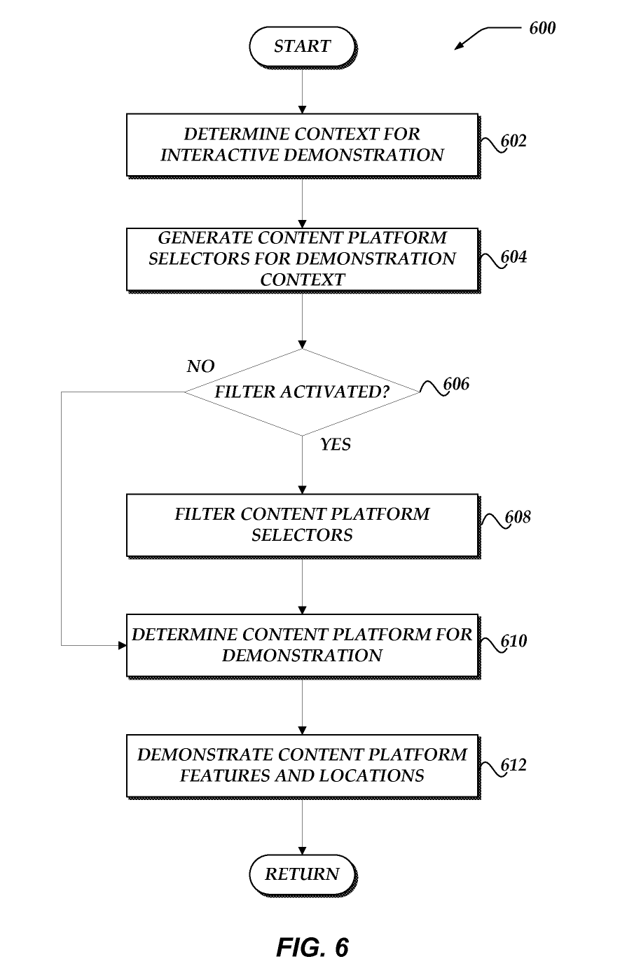

FIG. 6 shows an overview flowchart for process 600 for interactively displaying content platform information in accordance with the various embodiments. After a start block, at block 602, in at least one of the various embodiments, a context for the interactive demonstration may be determined. In at least one of the various embodiments, the kiosk application may be arranged to offer multiple context choices that may be used to drive the demonstration. For example, in at least one of the various embodiments, the kiosk application may include one or more consumer-oriented contexts—such as a “day in the life” of the consumers who may observe and/or interact with one or more content platforms. Also, in at least one of the various embodiments, the kiosk application may provide one or more technology-oriented contexts that enable the interactive demonstrations to be presented and/or guided based on the technology features available for the given content platforms.

At block 604, in at least one of the various embodiments, one or more content-platform selectors may be generated for the determined demonstration context. In at least one of the various embodiments, these selectors may represent one or more ways the user may explore the available content platforms.

For example, in at least one of the various embodiments, if a technology-oriented context is active, the selectors that may be generated may represent different technology features—such as RSS feeds, directional mapping, three dimensional (3D) displays, mobile computer applications, social network integration, gender recognition/detection, touch capability, or the like.

Likewise, in at least one of the various embodiments, if a consumer-oriented context may be active, the selectors that be generated may represent different locations and/or activities associated with one or more group of consumers.

For example, if the consumer context is a day-in-the-life context, the selectors may be arranged to reflect different places or activities where consumers may interact with a content platform—such as a shopping mall, a bar or lounge, taxi cab, grocery stores, gas stations, restaurants, airplanes, airports, gyms, offices/office buildings, or the like.

At decision block 606, in at least one of the various embodiments, if a filter is active, control may flow to block 608; otherwise, control may flow block 610. In at least one of the various embodiments, the kiosk application may be arranged to enable a user to activate one or more filters that may determine how the selectors may be displayed.

At block 608, in at least one of the various embodiments, since one or more filters are active, the selectors may be arranged accordingly. In at least one of the various embodiments, filters may be arranged to show or hide various selectors based on the filter that is selected. Filters may be based on technology features, locations, or the like. In at least one of the various embodiments, the kiosk application may be arranged to deemphasize the selectors that correspond to the filter rather than hiding them completing from the user. For example, by activating various technology feature filters, the user may be enabled to easily observe which selectors are associated with a given feature. At block 610, in at least one of the various embodiments, the kiosk application may determine the content platform for demonstrating. In at least one of the various embodiments, the user may select a selector, based on which the kiosk application may determine which content platform demonstration the user intends to interact with. At block 612, in at least one of the various embodiments, the kiosk application may interactively demonstrate the features, audience characteristics, pricing, technical features, or the like, that correspond to the one or more content platforms determined at block 610. Next, control may flow to a calling process.

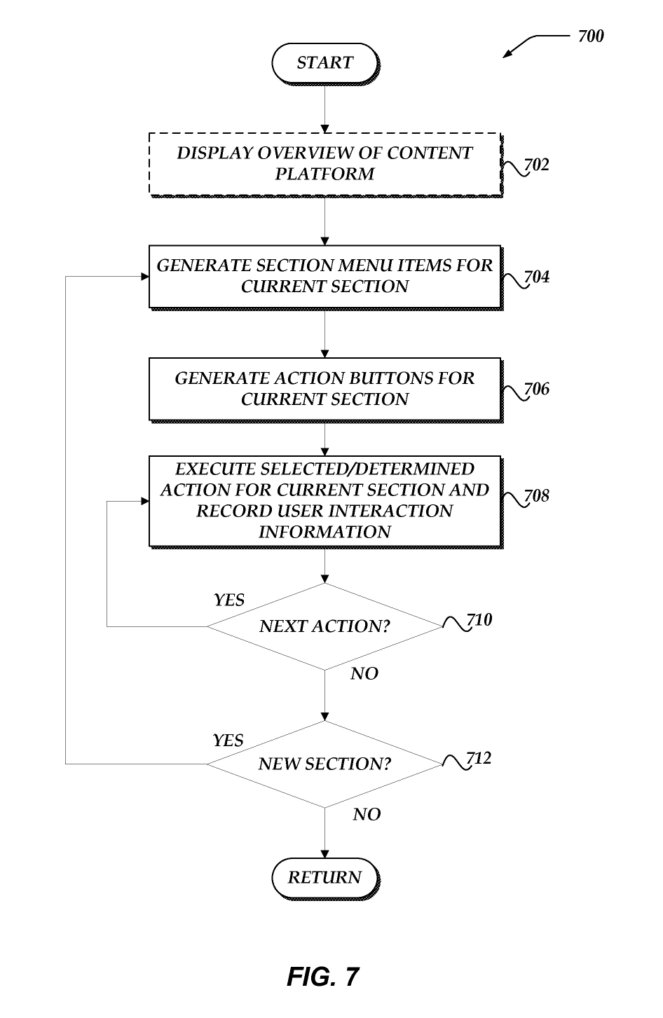

FIG. 7 shows an overview flowchart for process 700 for an interactive demonstration of a content platform in accordance with at least one of the various embodiments. After a start block, at block 702, in at least one of the various embodiments, optionally, the kiosk application may be arranged to display information that provides an overview of the content platform. In at least one of the various embodiments, the overview may be comprised of various media—including still images, video, audio, animations, or the like.

At block 704, in at least one of the various embodiments, the kiosk application may generate and/or display one or more section menu items that correspond to the current section. In at least one of the various embodiments, the demonstration may be configured to start at a default section if one has not been otherwise selected or determined. In at least one of the various embodiments, the number of sections may vary depending on the particular content platform that is associated with the selector that was activated. Also, in at least one of the various embodiments, the sections may be tailored to the user based on their credentials. For example, in at least one of the various embodiments, users associated with “executive” credentials may be enabled to view different sections than a user associated with “technical” credentials. In at least one of the various embodiments, the section menu items may be presented in a user interface of the kiosk application using one or more well-known techniques—such as drop down list, button lists, or the like.

At block 706, in at least one of the various embodiments, action buttons that correspond to the current section may be generated and/or displayed. In at least one of the various embodiments, each section may be associated with one or more action buttons. The number and type of action button may vary depending on the particular section that is active. In some cases, the kiosk application may be arranged to automatically execute one or more actions—such as playing a video or audio clip. Also, in at least one of the various embodiments, the kiosk application may be arranged to highlight one of the action buttons as a suggestion for the user. Examples of action buttons may include, play video, play audio, previous (section), next (section), take a picture, record (video/audio), pause, or the like.

In at least one of the various embodiments, the kiosk application may be arranged to vary the action buttons as well as the actions associated with the action buttons, depending on the user credentials. For example, a guest user might not be enabled to take a picture, whereas the feature may be enabled for a nonguest user.

At block 708, in at least one of the various embodiments, the selected or determined action for the current section may be executed. Likewise, in at least one of the various embodiments, the kiosk application may record any user interaction—including the selection of an action, the selection of current sections, the amount of dwell time for each action or section, or the like. Also, the action associated with the action button may vary depending on if the user is operating the kiosk application near a content platform demonstration station. For example, a play video button may activate video on the demonstration station rather than on the computer the kiosk application is operative on if the user is near the appropriate demonstration station. At decision block 710, in at least one of the various embodiments, if another or next action may be indicated, control may loop back to block 708; otherwise, in at least one of the various embodiments, control may flow to decision block 712. At decision block 712, in at least one of the various embodiments, if another section is selected or determined, control may loop back to block 704; otherwise, control may be returned to a calling process.

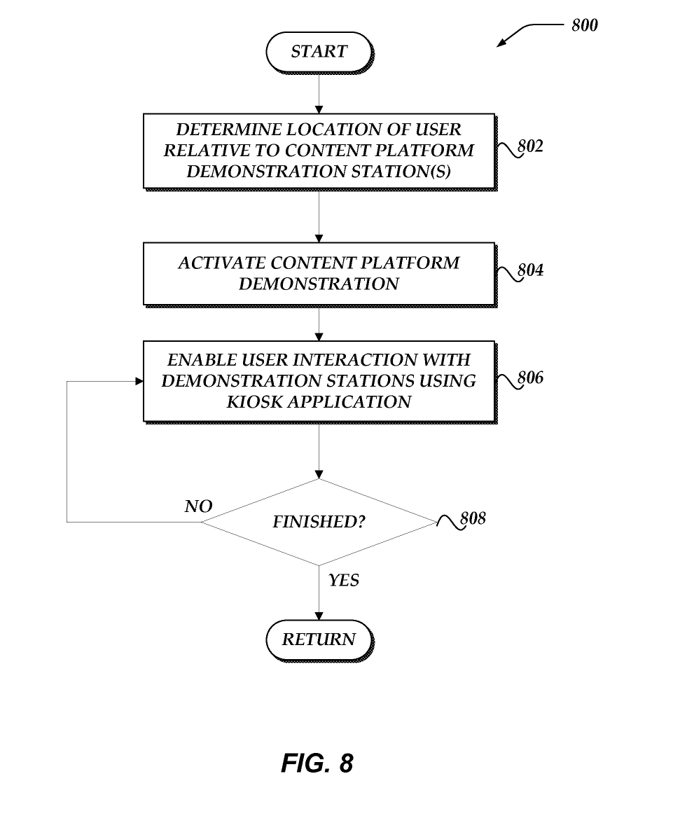

FIG. 8 shows a flowchart for process 800 for interactive demonstration of a content platform in accordance with at least one of the various embodiments. After a start block, at block 802, in at least one of the various embodiments, the physical location of a user relative to one or more content platform demonstration stations may be determined. In at least one of the various embodiments, the kiosk application may be arranged to determine if it is operative near a particular demonstration station. In at least one of the various embodiments, the kiosk application and the demonstration station may be enabled to communicate using one or more short range wireless technologies, such as, Bluetooth, NFC, or the like. In at least one of the various embodiments, the kiosk application may be arranged to authenticate with the demonstration station using one or more cryptographic techniques, such as, cryptographic certificate, public key infrastructure (PKI), passwords, pass phrases, or the like.

At block 804, in at least one of the various embodiments, the content platform demonstration may be activated. In at least one of the various embodiments, the demonstration may be activated on the kiosk application and the demonstration station. In at least one of the various embodiments, upon communicating with a kiosk application, the demonstration station may be enabled to communicate with the kiosk application. In at least one of the various embodiments, the kiosk application may be arranged to provide messages to the demonstration station that activate one or more actions on the demonstration station for illustrating the features of the content platform.

At block 806, in at least one of the various embodiments, the kiosk application may enable the user perform actions on the kiosk application that interact with the demonstration station. In at least one of the various embodiments, the kiosk application may be arranged to enable one or more of the section menu items and/or one or more of the action buttons to trigger actions on the demonstration station. For example, in at least one of the various embodiments, the kiosk application may be arranged to generate a “play video” action button that may trigger a video to be played on the demonstration station rather on than the client computer where the kiosk application is operative. In some cases, activating an action button on the kiosk application may trigger one action on the client computer where the kiosk application is operative and another action on the demonstration station.

At decision block 808, in at least one of the various embodiments, if the demonstration is finished, control may be returned to a calling process; otherwise, control may loop back to block 806.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks. The computer program instructions may also cause at least some of the operational steps shown in the blocks of the flowcharts to be performed in parallel. Moreover, some of the steps may also be performed across more than one processor, such as might arise in a multiprocessor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions, and program instruction means for performing the specified actions. It will also be understood that each block of the flowchart illustration, and combinations of blocks in the flowchart illustration, can be implemented by special-purpose hardware-based systems, which perform the specified actions or steps, or by combinations of special-purpose hardware and computer instructions. The foregoing examples should not be construed as limiting and/or exhaustive, but rather as an illustrative use case to show an implementation of at least one of the various embodiments of the invention.

### Illustrative Use Cases

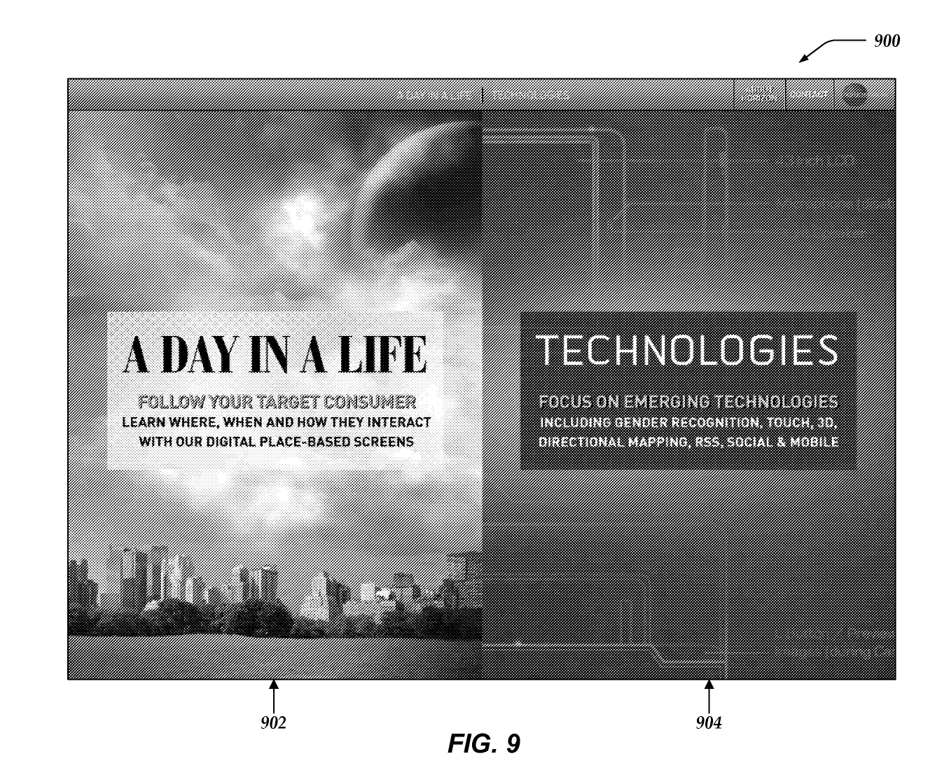

FIG. 9 shows interface 900 for determining a context for an interactive demonstration of content platforms in accordance with at least one of the embodiments. In at least one of the various embodiments, interface 900 may be a user interface screen generated by a kiosk application—such as kiosk application 216. In at least one of the various embodiments, user interface 900 may enable a user select among one or more contexts for viewing the demonstrations. For example, in at least one of the various embodiments, context 902 may be selected if a user wants to view and/or compare the different types of content platforms in terms of “a day in the life” for the target consumers. And, in this example, by selecting context 904 the user may be enabled to interact with a demonstration that may be oriented to the different technologies and/or capabilities of the content platforms.

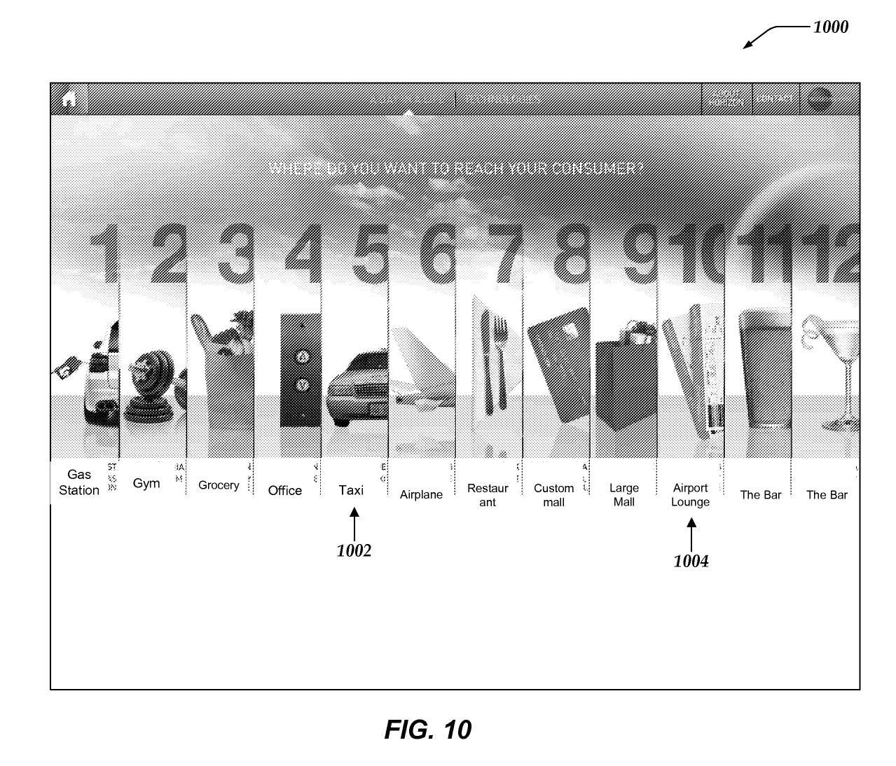

FIG. 10 shows interface 1000 for displaying one or more selectors that enable a user to select a content platform to demonstrate in accordance with at least one of the various embodiments. In at least one of the various embodiments, as discussed above, a kiosk application may be arranged to generate one or more selectors for different demonstration contexts (e.g., consumer point-of-view, technology oriented, or the like). For example, in at least one of the various embodiments, interface 1000 may comprise selectors for a consumer day-in-the-life oriented demonstration. Continuing with this example, the different options represented by the selectors in interface 1000 may be related to locations and/or activities that consumers may experience. In at least one of the various embodiments, interface 1000 may include various selectors for different locations/activities, including, but not limited to, gas stations, gyms, grocery shopping, offices/office building, taxis (e.g., selector 1002), airplanes, restaurants, custom malls, large/mainstream malls, airport lounges (e.g., selector 1004), bars, or the like.

In at least one of the various embodiments, if a user activates or otherwise selects a selector, the kiosk application may be arranged to initiate an interactive demonstration for one or more content platforms that may be associated with location or activities represented by the selector.

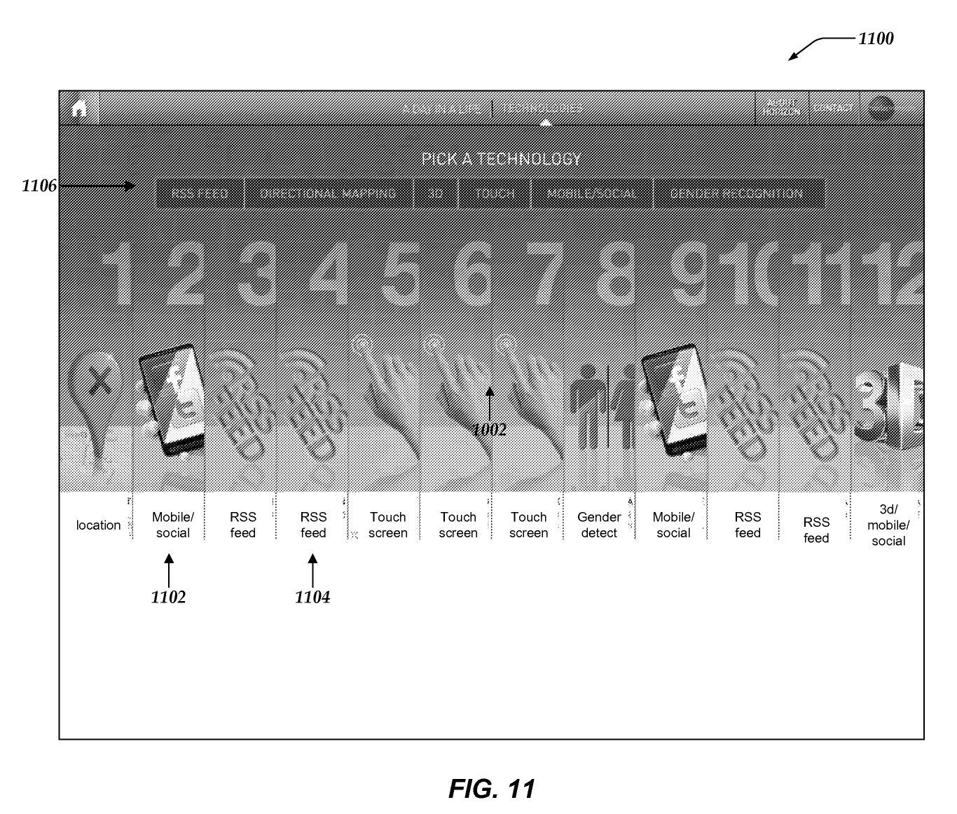

FIG. 11 shows interface 1100 for displaying one or more selectors that enable a user to select a content platform to demonstrate in accordance with at least one of the various embodiments. In at least one of the various embodiments, interface 1100 may comprise selectors arranged in terms of technology. The different options represented by the selectors in interface 1100 may be related to technology capabilities that a user may wish to explore. In at least one of the various embodiments, interface 1100 may include various selectors for different technologies—including, but not limited to, location, mobile/social, RSS feeds, touch screen, gender detection, 3D, or the like. For example, in at least one of the various embodiments, selector 1102 may be employed to initiate a demonstration of a content platform that may support one or more mobile telephones. Likewise, in at least one of the various embodiments, selector 1104 may be arranged for initiating demonstrations of content platforms that support RSS feed technology.

In at least one of the various embodiments, a kiosk application may be arranged to generate an interface that includes one or more filter bars for activating one or more filters to include or exclude technology areas that may be of interest to a user. For example, an interface, such as, interface 1100 may be arranged to include filter bar 1106 that includes filter options for various kinds of technology, such as, RSS feed, directional mapping, 3D touch, mobile/social, gender detection, or the like. In at least one of the various embodiments, if a user activates or otherwise selects a selector, the kiosk application may be arranged to initiate an interactive demonstration for one or more content platforms that support the technology represented by the selector.

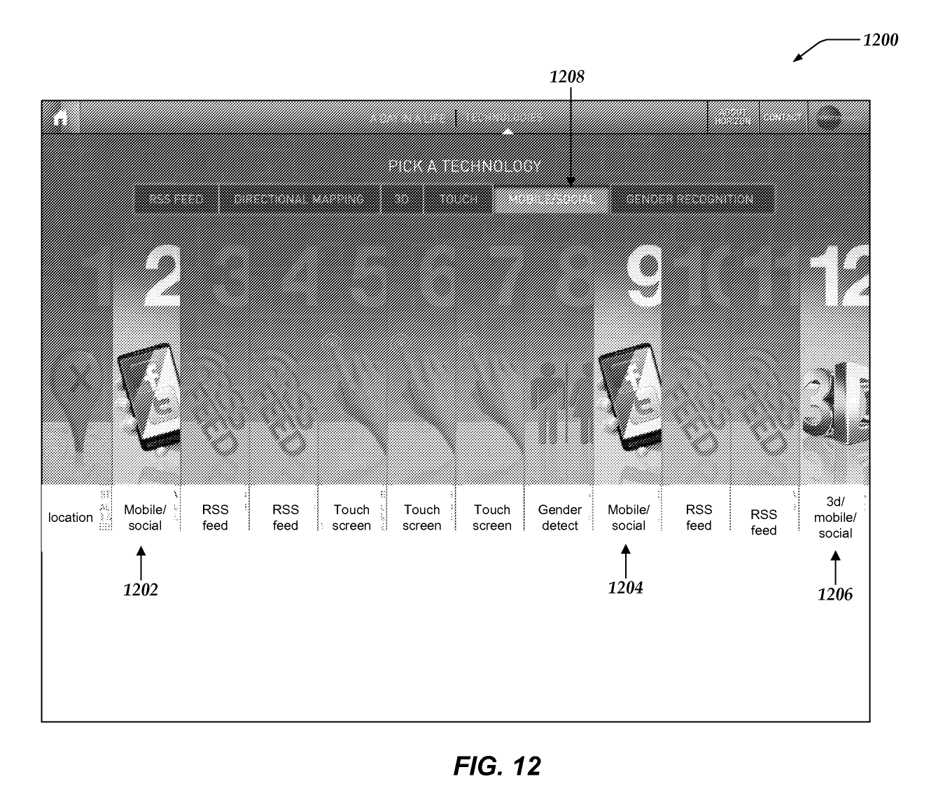

FIG. 12 shows interface 1200 with a filter activated in accordance with at least one of the various embodiments. In at least one of the various embodiments, as discussed above, a kiosk application, such as, kiosk application 216 may be arranged to enable the activation of a filter that may highlight or exclude selectors in accordance with the filter value. For example, in at least one of the various embodiments, selector 1202, selector 1204, and selector 1206 may be highlighted if filter 1208 (e.g., mobile/social) is activated. In this example, selectors associated with technology indicated in the filter bar may be highlighted enabling users to be guided to demonstrations of content platforms that employ the selected technology.

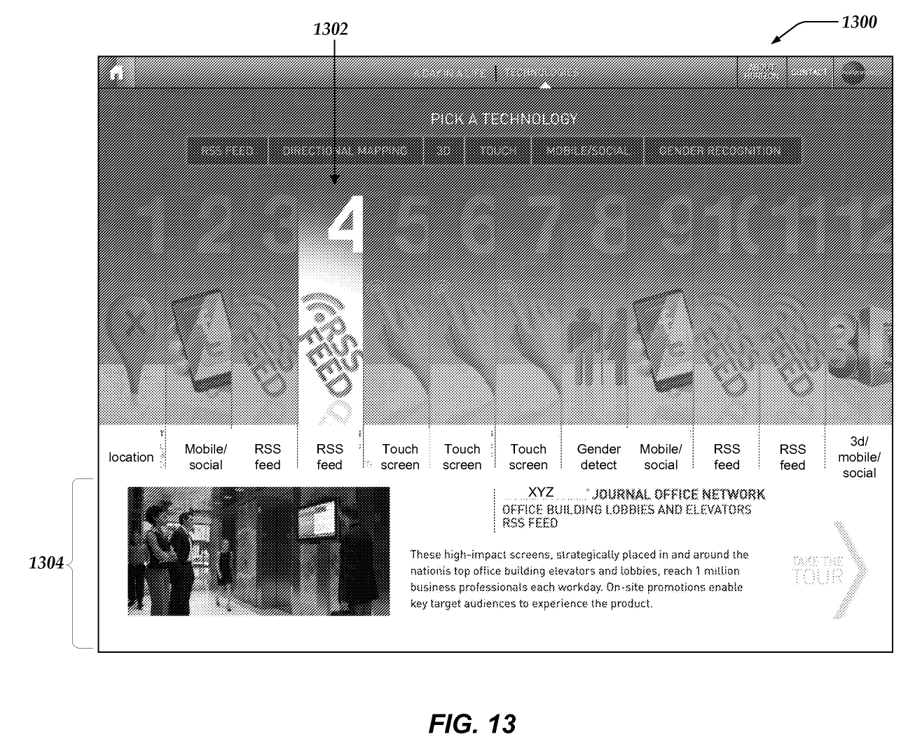

FIG. 13 shows interface 1300 with a selector that has been activated by a user in accordance with at least one of the various embodiments. In at least one of the various embodiments, if a selector may be activated, the kiosk application may be arranged to show a brief summary of the content platform that may be associated with the selector. For example, in at least one of the various embodiments, selector 1302 may be activated causing the kiosk application to generate and/or display summary 1304. In at least one of the various embodiments, if the kiosk application determines that the user is near a demonstration station that corresponds to the content platform, the selector may be automatically activated.

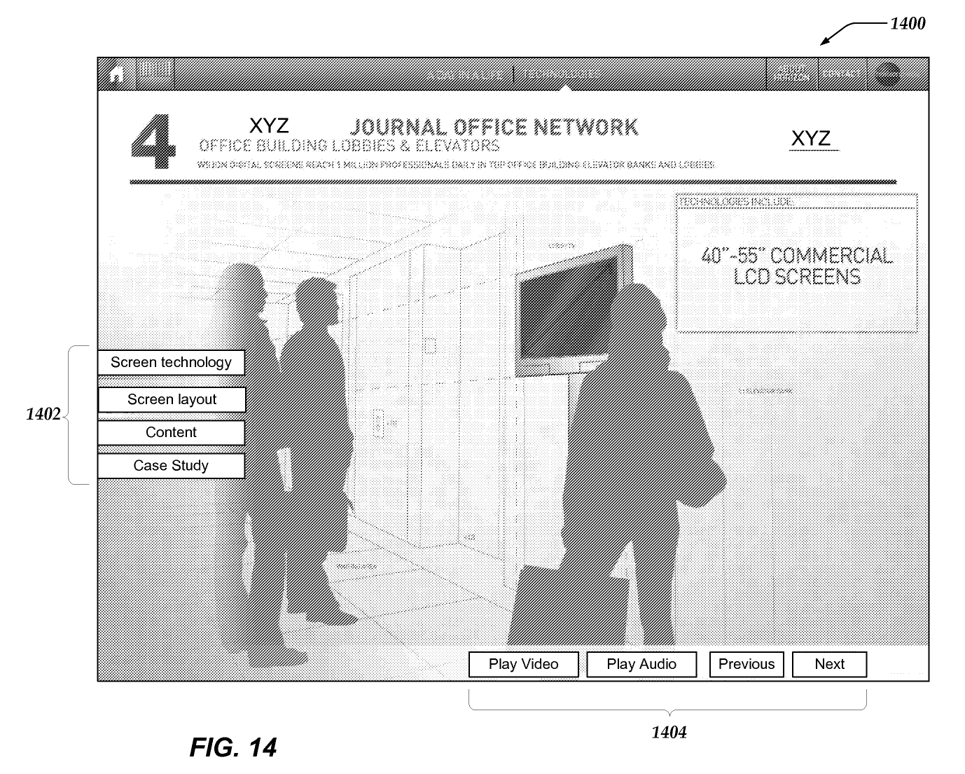

FIG. 14 shows interface 1400 for interacting with a content platform demonstration in accordance with at least one of the various embodiments. In at least one of the various embodiments, content platform demonstrations may be arranged to include one or more sections that may be indicated using section menu items, such as, section menus items 1402, which may include one or more sections related to the current content platform demonstration. For example, section menus items for demonstrations related to the technology and/or performance of a content platform may include, screen technology, screen layout, content, case study, or the like. Section menu items for demonstrations using consumer oriented context may include, fast-facts about the content platform, target audience information, consumer experience examples (e.g., videos, interactive display, audio, or the like), measurements, buying guidelines, or the like.

Further, in at least one of the various embodiments, each section of the demonstration may be associated with one or more action items determined for interacting with the demonstration. The particular selection and/or number of action items may vary depending on the section of the demonstration that may be active. For example, in at least one of the various embodiments, action items—such as action items 1404—may include action items for playing video, playing audio, previous section, next sections, or the like.

In at least one of the various embodiments, one of ordinary skill in the art will appreciate that section menu items and/or action items may vary depending on the particular composition of the current demonstration and/or the current section. The section menu items and action items shown in FIG. 14 are nonlimiting examples presented to help clarify the claimed subject matter. Accordingly, more or fewer section menu items and/or more or fewer action menu items as well as different arrangements of the interface are envisaged.

1. A method for interactively displaying demonstrations for types of content platforms that are operative to display content, the method being performed by a client computer that comprises one or more processors, a memory operatively coupled to at least one of the processors, and a computer-readable storage medium encoded with instructions executable by and operatively coupled to at least one of the processors, the method comprising:
displaying, on a graphical user interface, a plurality of demonstration-context selectors including at least one of:
a technology-demonstration-context selector; and
a consumer-demonstration-context selector;
upon activation of the technology-demonstration-context selector by a user, generating, on the graphical user interface, a plurality of demonstration selectors, wherein each demonstration selector relates to a different type of content-platform technology, and corresponds to a demonstration for a type of content platform which employs that content-platform technology;
upon activation of the consumer-demonstration-context selector by a user, generating, on the graphical user interface, a plurality of demonstration selectors, wherein each demonstration selector relates to a location or activity that a consumer may experience, and corresponds to a demonstration for a type of content platform that reaches the consumer during that location-or-activity experience;
upon activation of at least one demonstration selector by a user, performing further actions comprising:
displaying, on the graphical user interface or on a demonstration station, at least a section of the demonstration that corresponds to the activated demonstration selector;
generating, on the graphical user interface, at least one section menu item that corresponds to the currently displayed section of the demonstration; and
generating, on the graphical user interface, at least one action button that corresponds to the currently displayed section of the demonstration;
upon interaction by the user with the at least one section menu item and the at least one action button, generating interaction information that corresponds to the user's interaction with the at least one section menu item and the at least one action button; and
communicating the interaction information to at least a kiosk management server computer, wherein the kiosk management server computer generates a report that includes at least the interaction information.

2. The method of claim 1, further comprising:
generating, on the graphical user interface, a plurality of technology-feature selectors;
upon activation of at least one technology-feature selector by the user, determining a portion of the plurality of demonstration selectors based at least on the activated technology-feature selector; and
enabling only the determined portion of the plurality of demonstration selectors for activation by the user.

3. The method of claim 1;
wherein generating the plurality of demonstration selectors further comprises:
determining the plurality of demonstration selectors that are available to the user based on at least a credential that corresponds to the user.

4. (canceled)

5. (canceled)

6. The method claim 1;
wherein the section of the demonstration that corresponds to the activated demonstration selector is displayed a demonstration station; and
wherein the method further comprises communicating with the demonstration station to enable the user interaction with the at least one section menu item or the at least one action button to at least trigger an action on the demonstration station.

7. (canceled)

8. The method of claim 1;
wherein the section of the demonstration that corresponds to the activated demonstration selector is displayed a demonstration station; and
wherein the method further comprises:
determining the demonstration station based on the activated demonstration selector; and
guiding the user to the determined demonstration station.

9. A network computer for interactively displaying demonstrations for types of content platforms that are operative to display content, comprising:
a transceiver configured to communicate over a network;
a memory which stores at least instructions;
a processor device that is operatively coupled to the memory so as to be programmed at least to enable operations comprising:
displaying, on a graphical user interface, a plurality of demonstration-context selectors including at least one of:
a technology-demonstration-context selector; and
a consumer-demonstration-context selector;
upon activation of the technology-demonstration-context selector by a user, generating, on the graphical user interface, a plurality of demonstration selectors, wherein each demonstration selector relates to a different type of content-platform technology, and corresponds to a demonstration for a type of content platform which employs that content-platform technology;
upon activation of the consumer-demonstration-context selector by a user, generating, on the graphical user interface, a plurality of demonstration selectors, wherein each demonstration selector relates to a location or activity that a consumer may experience, and corresponds to a demonstration for a type of content platform that reaches the consumer during that location-or-activity experience;
upon activation of at least one demonstration selector by a user, enabling further actions, comprising:
displaying, on the graphical user interface or on a demonstration station, at least a section of the demonstration that corresponds to the activated demonstration selector;
generating, on the graphical user interface, at least one section menu item that corresponds to the currently displayed section of the demonstration; and
generating, on the graphical user interface, at least one action button that corresponds to the currently displayed section of the demonstration;
upon interaction by the user with the at least one section menu item and the at least one action button, generating interaction information that corresponds to the user's interaction with the at least one section menu item and the at least one action button; and
communicating the interaction information to at least a kiosk management server computer, wherein the kiosk management server computer generates a report that includes at least the interaction information.

10. The network computer of claim 9;
wherein the processor device is programmed to enable operations further comprising:
generating, on the graphical user interface, a plurality of technology-feature selectors;
upon activation of at least one technology-feature selector by the user, determining a portion of the plurality of demonstration selectors based at least on the activated technology-feature selector; and
enabling only the determined portion of the plurality of demonstration selectors for activation by the user.

11. The network computer of claim 9;
wherein generating the plurality of demonstration selectors further comprises:
determining the plurality of demonstration selectors that are available to the user based on at least a credential that corresponds to the user.

12. (canceled)

13. (canceled)

14. The network computer of claim 9;
wherein the section of the demonstration that corresponds to the activated demonstration selector is displayed a demonstration station; and
wherein the processor device is programmed to enable operations further comprising:
communicating with the demonstration station to enable the user interaction with the at least one section menu item or the at least one action button to at least trigger an action on the demonstration station.

15. (canceled)

16. The network computer of claim 9;
wherein the section of the demonstration that corresponds to the activated demonstration selector is displayed a demonstration station; and
wherein the processor device is programmed to enable operations further comprising:
determining the demonstration station based on the activated demonstration selector and guiding the user to the determined demonstration station.

17. A processor-readable nontransitive storage media that includes instructions for interactively displaying demonstrations for types of content platforms that are operative to display content, wherein execution of at least a portion of the instructions by a processor device enables operations comprising:
displaying, on a graphical user interface, a plurality of demonstration-context selectors including at least one of:
a technology-demonstration-context selector; and
a consumer-demonstration-context selector;
upon activation of the technology-demonstration-context selector by a user, generating, on the graphical user interface, a plurality of demonstration selectors, wherein each demonstration selector relates to a different type of content-platform technology, and corresponds to a demonstration for a type of content platform which employs that content-platform technology;
upon activation of the consumer-demonstration-context selector by a user, generating, on the graphical user interface, a plurality of demonstration selectors, wherein each demonstration selector relates to a location or activity that a consumer may experience, and corresponds to a demonstration for a type of content platform that reaches the consumer during that location-or-activity experience;
upon activation of at least one demonstration selector by a user, enabling further actions, comprising:
displaying, on the graphical user interface or on a demonstration station, at least a section of the demonstration that corresponds to the activated demonstration selector;
generating, on the graphical user interface, at least one section menu item that corresponds to the currently displayed section of the demonstration; and
generating, on the graphical user interface, at least one action button that corresponds to the currently displayed section of the demonstration;
upon interaction by the user with the at least one section menu item and the at least one action button, generating interaction information that corresponds to the user's interaction with the at least one section menu item and the at least one action button; and
communicating the interaction information to at least a kiosk management server computer, wherein the kiosk management server computer generates a report that includes at least the interaction information.

18. The media of claim 17;
wherein the execution of the at least portion of the instructions by the processor device enables operations further comprising:
generating, on the graphical user interface, a plurality of technology-feature selectors;
upon activation of at least one technology-feature selector by the user, determining a portion of the plurality of demonstration selectors based at least on the activated technology-feature selector; and
enabling only the determined portion of the plurality of demonstration selectors for activation by the user.

19. The media of claim 17;
wherein generating the plurality of demonstration selectors further comprises:
determining the plurality of demonstration selectors that are available to the user based on at least a credential that corresponds to the user.

20. (canceled)

21. The media of claim 17;
wherein the section of the demonstration that corresponds to the activated demonstration selector is displayed a demonstration station; and
wherein the execution of the at least portion of the instructions by the processor device enables operations further comprising:
determining the demonstration station based on the activated demonstration selector and guiding the user to the determined demonstration station.

22. The media of claim 17,
wherein the section of the demonstration that corresponds to the activated demonstration selector is displayed a demonstration station; and
wherein the execution of the at least portion of the instructions by the processor device enables actions further comprising:
communicating with the demonstration station to enable the user interaction with the at least one section menu item or the at least one action button to at least trigger an action on the demonstration station.

23. (canceled)

24. A system for interactively displaying demonstrations for types of content platforms that are operative to display content, comprising:
a client computer, including:
a transceiver configured to communicate over a network;
a memory which stores at least instructions;
a processor device that is operatively coupled to the memory so as to be programmed at least to enable operations comprising:
displaying, on a graphical user interface, a plurality of demonstration-context selectors including at least one of:
a technology-demonstration-context selector; and
a consumer-demonstration-context selector;
upon activation of the technology-demonstration-context selector by a user, generating, on the graphical user interface, a plurality of demonstration selectors, wherein each demonstration selector relates to a different type of content-platform technology, and corresponds to a demonstration for a type of content platform which employs that content-platform technology;
upon activation of the consumer-demonstration-context selector by a user, generating, on the graphical user interface, a plurality of demonstration selectors, wherein each demonstration selector relates to a location or activity that a consumer may experience, and corresponds to a demonstration for a type of content platform that reaches the consumer during that location-or-activity experience;
upon activation of at least one demonstration selector by a user, enabling further actions, comprising:
displaying, on a demonstration station, at least a section of the demonstration that corresponds to the activated demonstration selector;
generating, on the graphical user interface, at least one section menu item that corresponds to the currently displayed section of the demonstration; and
generating at least one action button that corresponds to the currently displayed section of the demonstration;
upon interaction by the user with the at least one section menu item and the at least one action button, generating interaction information that corresponds to the user's interaction with the at least one section menu item and the at least one action button; and
communicating the interaction information to at least a kiosk management server computer; and
the demonstration station, which comprises:
a display.

25. The system of claim 24;
wherein the processor device of the client computer is programmed to enable operations further comprising:
generating, on the graphical user interface, a plurality of technology-feature selectors;
upon activation of at least one technology-feature selector by the user, determining a portion of the plurality of demonstration selectors based at least on the activated technology-feature selector; and
enabling only the determined portion of the plurality of demonstration selectors for activation by the user.

26. The system of claim 24;
wherein generating the plurality of demonstration selectors further comprises:
determining the plurality of demonstration selectors that are available to the user based on at least a credential that corresponds to the user.

27. (canceled)

28. The system of claim 24;
wherein the section of the demonstration that corresponds to the activated demonstration selector is displayed a demonstration station; and
wherein the processor device of the client computer is programmed to enable operations further comprising:
determining the demonstration station based on the activated demonstration selector and guiding the user to the determined demonstration station.

29. The system of claim 24;
wherein the section of the demonstration that corresponds to the activated demonstration selector is displayed a demonstration station; and
wherein the processor device of the client computer is programmed to enable operations further comprising:
communicating with a demonstration station to enable the user interaction with the at least one section menu item or the at least one action button to at least trigger an action on the demonstration station.

30. (canceled)
